(19) United States
(12) Patent Application Publication
(10) Pub. No.: US 2005/0096756 A1
(43) Pub. Date: May 5, 2005

(54) Electric control system

(75) Inventors: Erhard Quast, Friesenhagen (DE); Ulrich Sielemann, Stuttgart (DE)

Correspondence Address: OSTROLENK FABER GERB & SOFFEN, 1180 AVENUE OF THE AMERICAS, NEW YORK, NY, 100368403, US

(73) Assignee: Norgren GmbH

(21) Appl. No.: 10/976,963

(22) Filed: Oct. 29, 2004

(30) Foreign Application Priority Data
Oct. 31, 2003 (DE) DE 103 51 328.0
Nov. 11, 2003 (DE) DE 103 53 295.1

(51) Int. Cl. G05B 15/00; G05B 11/01

(52) U.S. Cl. 700/19; 700/20; 700/1

(57) ABSTRACT

An electric control system including at least one electric module for the control of at least one electric consumer. The at least one electric module has an arrangement for connection to other electric modules that includes at least one optoelectronic transmitter and receiver. Each electric module has a circuit arrangement for processing and routing the optoelectronic signal and for controlling the electric consumer.

### BACKGROUND OF THE INVENTION

The present invention relates to an electric control system having at least one electric module for controlling at least one electric consumer.

Modular electric control systems of this kind are used in a variety of technical fields, especially in the field of building services installations or pneumatic or hydraulic devices.

One application is, for example, the use in modular valve stations that comprise a plurality of linked valve blocks. A pneumatic or hydraulic valve unit, comprising a valve block carrying at least one electromagnetic operating block, has been disclosed, for example, in DE 39 10 913 A1. The valve block can be attached to a junction block, which junction block contains means for the connection of further junction blocks. Electric supply and/or control lines run through the junction block, and a plug-in device connected to such lines is arranged in those sides of the junction block that contact the corresponding sides of the further junction blocks when the further junction blocks are connected. In addition, electric connection means are provided for connection of the lines in the junction block to electric terminals in the at least one operating block. This makes cabling of the valve unit superfluous, even if a plurality of valve units is fitted in series, the electric connections being made automatically as the valve units are fitted together.

DE 43 12 757 A1 describes an electronic control system for a modular valve station where a modular control unit is connected to modules via a bus system and each module comprises a programmable address decoder. Means are provided for sequential configuration of the modules and for automatic allocation of individual addresses to the different modules. This permits the valve station to be built up or extended as desired, the connected modules being automatically identified and assigned addresses.

Valve units of this kind, also known as valve islands, where a plurality of valves are arranged as one structural unit and which are provided with an electric central plug (multipole) or a field bus interface with corresponding digital outputs, are standard components in automation technology. Such modular systems, where the valve function can be built up in modular form from ever the same groups, find use especially in the construction of special-purpose machines. Electric lines or bus systems are used for addressing the different modules.

One disadvantage of these known control systems, especially when used for valve stations, is the presence of electric plug-in connections which not only can be distorted, for example, or damaged in some other way but frequently have to be sealed when used in pneumatic systems, and which in addition have to meet stringent demands regarding their mechanical tolerances.

### SUMMARY OF THE INVENTION

It is, therefore, an object of the present invention to provide an electric control system which can do largely without any electric plug-in connections.

The invention achieves this object by a control system having at least one electric module with at least one optoelectronic transmitter and receiver for connecting the electric module to other modules. Each module further has a circuit arrangement for processing and routing the optoelectronic signal and for controlling the electric consumer.

The control system according to the invention permits data to be transmitted by optical means. Plug-in connections are not required. Accordingly, the before-mentioned problems connected with plug-in connections are eliminated from the very beginning.

The electric module can be realized in the most different ways. According to one advantageous embodiment, at least one electric module comprises at least one stored-program control.

Purely principally, such an electric control unit may be used to control electric consumers or electric loads of any kind. One can imagine, for example, its use in building services automation applications, where doors, for example, have to be opened or closed, light has to be switched on and off, shutters and other darkening and/or shading systems have to be opened or closed, and heating valves have to be controlled, and the like.

An especially favorable use of such a modular electric control system is in connection with valve blocks of the kind described above. Accordingly, one advantageous embodiment provides that the at least one electric consumer is a valve module of a modular valve station.

That valve module preferably comprises fluidic channels that can be connected to corresponding fluidic channels of another valve module and that comprise at least one electrically controllable valve.

One advantageous embodiment provides that each electric module comprises at least one optoelectronic transmitter means for transmitting a data signal and at least one optoelectronic transmitter means for transmitting a clock signal. Further, each electric module comprises at least one optoelectronic receiver means for receiving a data signal and at least one optoelectronic receiver means for receiving a clock signal. In this way, two signals, i.e. a data signal (DATA signal) and a clock signal (CLOCK signal) can be received by each electric module and transmitted to other electric modules, or can be received by a central module or transmitted to the latter. Based on these signals only it is then possible for the electric modules to control every electric consumer, for example every valve module.

In order to permit data to be returned from the electric modules, for example to a central control module, it may be provided according to one advantageous embodiment that each electric module comprises three optical transmission channels and, thus, three optoelectronic receiver means and three optoelectronic transmitter means. In this case, a channel for the receipt of data and a channel for transmission of data are provided in addition to an optical channel for the clock signal. Modules of this kind are used, for example, in connection with a field bus interface where electrically controllable systems both receive clock signals and transmit signals to the control module, a condition found, for example, with external valves, position sensors, or the like, of pneumatic cylinders, for example.

Purely principally, the optoelectronic receiver means and transmitter means may be configured in the most different ways. One simple and low-cost and, therefore, advantageous embodiment provides that the transmitter means are photodiodes and the receiver means are phototransistors.

The circuit arrangement is, preferably, designed to permit sequential processing and routing of the signals received/transmitted. This then permits transmission of the signals according to the shift-register principle which provides the advantage that no addressing of the different electric modules is required. Instead, the address is defined in this case by the physical position of the electric module and, thus, of the valve module as such, as will be described hereafter in more detail.

Optical data transmission is very immune to interference, compared with guided data transmission. In addition, costly measures to ensure electromagnetic compatibility are not necessary in this case. Moreover, the entire digital logic required for handling the serial transmission of data can be realized using a simple single-chip microcontroller or a programmable logic module.

One advantageous embodiment provides not only for contactless transmission of the clock signals, but also for contactless energy transfer in that contactless energy transfer means, ensuring the supply of the valves with energy, are arranged in each electric module.

According to one advantageous embodiment, these contactless energy transfer means consist of a first iron-core element with a primary winding arranged in the central clock module, and a second iron-core element with secondary windings and rectifiers arranged in the electric modules and assigned to each valve, the first iron-core element and one or more of the second iron-core elements forming a closed iron core for contactless inductive voltage supply to the valves.

The second iron-core elements arranged in the electric modules are designed, on the one hand, as through elements and, on the other hand, as terminating elements.

Other advantages and features of the invention are the subject of the description that follows and of the illustrations of embodiments in the drawings.

### BRIEF DRESCRIPTION OF THE DRAWINGS

In the drawing

FIG. 1 shows a diagrammatic view of a modular valve station provided with an electric control system according to the invention;

FIG. 2 shows a diagrammatic representation of the transmitted data signals;

FIG. 3 shows a diagrammatic representation of two electric modules according to a different embodiment of the invention; and

FIG. 4 shows a diagrammatic representation of a valve station with contactless energy-transfer means according to another embodiment of the invention.

### DETAILED DESCRIPTION OF THE INVENTION

A valve station indicated generally by reference numeral 100 comprises a central control module 200 to which are connected a plurality of identically designed electric modules 300. Each electric module 300 comprises optoelectronic receiver means 310, 320 and optoelectronic transmitter means 340, 350 which are connected to a digital logic unit 370 by means of which a valve 530, arranged in a valve module 500, can be operated in a manner known as such, by electric means via a drive with a winding 380. The valve module 500 comprises fluidic channels 520 for the supply of a fluid. The electric modules 300 comprise plug-in contacts 391, 392, 393, 394 as part of the energy supply system.

As shown in FIG. 1, each electric module 300 can be connected to another module or to the central control module 200. The central control module 200 likewise comprises for this purpose optoelectronic transmitter means 240, 250 and plug-in contacts 293, 294 for the supply of energy.

Signal transmission from the central control module 200 to the electric modules 300, and between the different electric modules 300, is effected optically in the way described hereafter. Each module 300 comprises two optoelectronic receiver means, realized for example by a phototransistor 310, 320 adapted to receive serial data, as illustrated in FIG. 1, and two optoelectronic transmitter means, realized for example by the photodiodes 340, 350 adapted to transmit the data to the next electric module 300, as illustrated in FIG. 1. As regards the circuit logic, the entire modular valve station 100 constitutes a shift register with two optical channels formed by mutually associated transmitter and receiver means 240, 250; 340, 350 or 310, 320. The one optical channel serves to transmit the data signal, the other optical channel serves to transmit the clock signal.

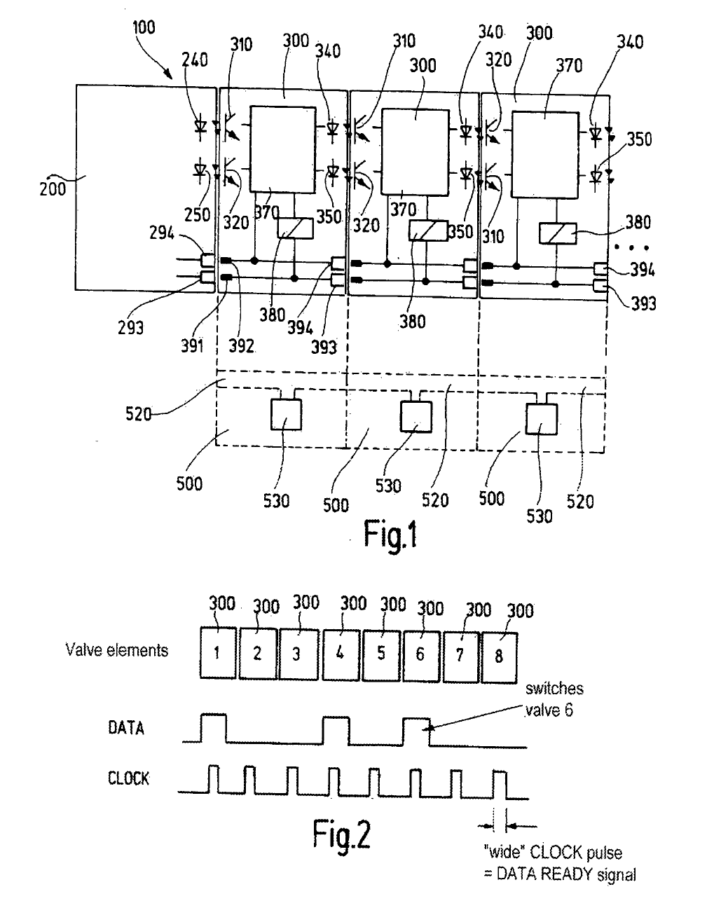

In FIG. 2, signal transmission is illustrated diagrammatically by means of eight electric modules 300 numbered 1 to 8 in FIG. 2. If, for example, the electric modules numbered 1, 4 and 6 are to switch the valves 530 associated to them, respectively, a clock signal (“CLOCK”) comprising eight square-wave pulses equally spaced in time will be transmitted. The last square-wave pulse is slightly wider thereby signaling the end of the signal so that no additional optical transmission channel is required for transmission of the so-called “DATA READY signal”. Instead, the clock signal as such is encoded in this way. Associated to the clock signal is a data signal (“DATA”) which has only one square-wave pulse at the time of the first, fourth and sixth square-wave pulses of the clock signal. This signal is processed in the digital logic unit 370 of the electric module 300 so that each of the first, fourth and sixth electric modules 300 switches the respective associated drive 380 and, thus, the valve 530 associated to the respective electric module.

Accordingly, the clock signal acts to shift a serial data stream into the different electric modules 300. Via the other “DATA READY” signal, information is then transmitted to the coils of the electromagnetic drives 380. This shift-register principle provides the advantage that no addressing of the different electric modules 300 is needed. The address is derived automatically from the physical position of the electric module 300. Compared with a guided data transmission system, optical data transmission is very immune to interference. In addition, there is no need for costly measures to guarantee electromagnetic compatibility.

The entire digital logic needed to handle serial data transmission can be realized by the use of a simple single-chip microcontroller or a programmable logic module.

The electric modules 300 may, for example, comprise a stored-program control (SPS) provided, in combination with, for example, a valve island or modules for data input and output, as a substitute for a hard-wired bus for communication with the central control module 200, which latter may comprise a CPU, for example. In this connection, a single or a plurality of modules 300 linked in this way, with or without connection to other electrically controllable mechanical or electric systems, are likewise imaginable.

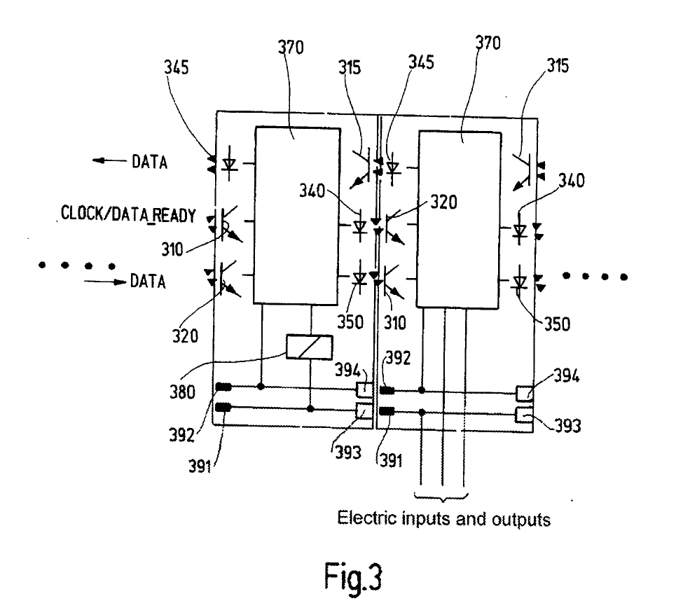

In the embodiment illustrated in FIG. 3, identical features are identified by the same reference numerals as in the embodiment illustrated in FIG. 1 so that full reference is made to the above explanations with respect to those features.

Compared with the modules 300 illustrated in FIG. 1, the electric modules 300 illustrated in FIG. 3 comprise an additional optoelectronic transmitter means 345 in the form of a photodiode and an additional optoelectronic receiver means 315 in the form of a phototransistor, associated to the diode 345, which form together a further third optical channel. This channel serves as data output. Electric modules 300 of this kind can be used, for example, in valve stations which comprise a field bus interface and which are frequently also provided with additional electric inputs and outputs, for example for connection to external valves or position sensors of pneumatic cylinders, or the like. The third channel allows communication with the central control module 200 and/or with other modules 300.

In each of FIGS. 1 and 3 only a single electric drive 380 is shown in the form of a coil. It is, however, understood that the invention is not limited to that embodiment and that two drives, especially two coils, or more than two coils/drives may be provided.

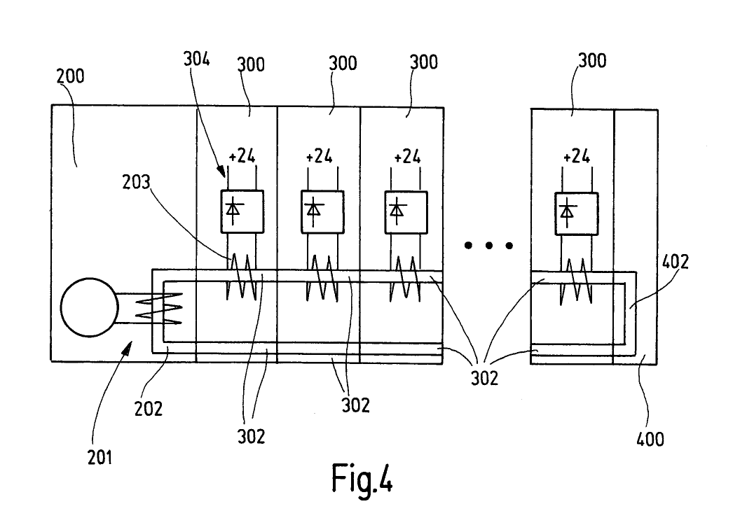

According to another embodiment illustrated in FIG. 4, a contactless energy supply system is provided in addition to the contactless signal transmission system described above. For clarity's sake the optical signal transmission channels illustrated in FIGS. 1 and 3 have been omitted in FIG. 4 so that only the contactless energy transfer path can be seen, which will be described hereafter in more detail.

The central control module 200 comprises a first iron-core element 202 with a primary winding 201. Each electric module 300 comprises a further iron-core or ferrite-core element 302, adapted to that first iron-core element 202, each having a secondary winding 203 and a rectifier 304. For closing the ferromagnetic circuit, an iron-core terminating element 402 is arranged in a terminating element 400. The primary winding 201 now serves to inject an alternating current which is tapped by the secondary windings 203 in each of the electric modules 300, and is rectified by the rectifiers 304. Thus, energy transfer is effected inductively, without any need for plug-in contacts. The ferromagnetic circuit elements 202, 302 and 402 are fully integrated, for example potted, in the control module 200, in the electric modules 300 and in the terminating element 400.

The above description refers to an electric control system for a valve station or valve island, by way of example. It is, however, understood that the invention is not limited to that use in a valve station or valve island, but is suited for use in other technical fields as well, for example in building services automation where, similarly, a plurality of electric installations arranged in sort of a modular system need to be controlled.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. An electric control system, comprising at least one electric module for control of at least one electric consumer, the at least one electric module includes an arrangement for connection to other electric modules, the arrangement for connection to other electric modules including at least one optoelectronic transmitter and at least one optoelectronic receiver, each electric module including a circuit arrangement for processing and routing an optoelectronic signal and for controlling the electric consumer.

2. The control system as defined in claim 1, wherein the circuit arrangement comprises a stored-program control (SPS).

3. The control system as defined in claim 1, wherein the at least one electric consumer is a valve module of a modular valve station.

4. The control system as defined in claim 3, wherein the valve module comprises fluidic channels that are connectable to corresponding fluidic channels of another valve module, and at least one electrically controllable valve.

5. The control system as defined in claim 1, wherein each electric module comprises at least one optoelectronic transmitter for transmitting a data signal and at least one optoelectronic transmitter for transmitting a clock signal.

6. The control system as defined in claim 1, wherein each electric module comprises at least one optoelectronic receiver for receiving a data signal and at least one optoelectronic receiver for receiving a clock signal.

7. The control system as defined in claim 1, wherein the transmitter includes a photodiode.

8. The control system as defined in claim 1, wherein the receiver includes a phototransistor.

9. The control system as defined in claim 1, wherein the circuit arrangement is designed for sequential processing and routing of signals received.

10. The control system as defined in claim 1, and further comprising countless energy-transfer components provided in each electric module for ensuring an energy supply.

11. The control system as defined in claim 10, and further comprising a central module, the contactless energy-transfer components being constituted by a first ferrite or iron-core element with a primary winding arranged in the control module, and second ferrite or iron-core elements with secondary windings and rectifiers associated with each electric module, the first ferrite or iron-core element and at least one of the second ferrite or iron-core elements forming a ferrite or iron-core for inductive energy supply.

12. The control system as defined in claim 11, and further comprising a ferrite or iron core terminating element arranged to close the ferrite or iron core.
